(19) United States
(12) Patent Application Publication
(10) Pub. No.: US 2013/0074627 A1
(43) Pub. Date: Mar. 28, 2013

(54) WORM WHEEL GEAR FOR BLDC MOTOR

(71) Applicant: Hoosang PARK, Hwaseong-si (KR)

(72) Inventor: Hoosang PARK, Hwaseong-si (KR)

(73) Assignee: HYUNDAI MOTOR COMPANY, Seoul (KR)

(21) Appl. No.: 13/307,696

(22) Filed: Nov. 30, 2011

(30) Foreign Application Priority Data
Sep. 23, 2011 (KR) 10-2011-0096303

(51) Int. Cl. F16H 55/17

(52) U.S. Cl. 74/458

(57) ABSTRACT

A worm wheel gear for a BLDC motor transmits the operation of a shift gear of an armature unit in a BLDC motor. The worm wheel gear may include a worm wheel-threaded portion formed on the outer circumferential surface with one side of a thread groove recessed and open and the other side of the thread groove closed, a worm wheel central shaft formed at the center portion, and internal support members protruding from the worm wheel central shaft and connected to the inner circumferential surface of the worm wheel-threaded portion to support the worm wheel-threaded portion. Therefore, it is possible to improve efficiency of transmitting operation and reduce operational noise by increasing the contact surface between the worm wheel-threaded portion and the shift gear.

### CROSS-REFERENCE TO RELATED APPLICATIONS

The present application claims the priority of Korean Patent Application Number 10-2011-0096303 filed Sep. 23, 2011, the entire contents of which application is incorporated herein for all purposes by this reference.

### BACKGROUND OF INVENTION

1. Field of Invention

The present invention relates to a worm wheel gear for a BLDC (sunroof) motor, and particularly, to the shape of a worm wheel gear for efficiently transmitting the operation of a shift gear of the armature unit of a BLDC (Brush-Less Direct Current) motor.

2. Description of Related Art

BLDC motors are motors without a brush to minimize an operational noise and reduce a radio noise and used as a driving source of devices requiring a low noise, such as a device for driving the sunroof of vehicles.

FIG. 1 is a perspective view of a worm wheel gear for a BLDC motor of the related art, which shows the shape of a common worm wheel gear. The worm wheel gear for a BLDC motor or the related art has a structure having threads open in both directions, as indicated by ‘A’ in FIG. 1, and in which, the threaded portion of the gear and the internal structure supporting the driving shaft are formed in an integral body, as indicated by ‘B’ in FIG. 1.

However, in the worm wheel gear for a BLDC motor of the related art, matching is implemented through the ends of the threads to prevent wear or breaking due to an excessive engaging force with the shift gear by the shape indicated by ‘A’, such that it is difficult to increase transmission efficiency by increasing the maximum contact area with the shift gear.

Further, the worm wheel gear for a BLDC motor of the related art has a problem in that noise increases, because stress generated by excessive engagement in matching with the shift gear is easily transmitted to the entire worm wheel gear, including the driving shaft, due to the structure indicated by ‘B’.

In particular, users may be displeased with a small operational noise in a worm wheel gear for a BLDC motor that is applied to a device for driving a sunroof of a vehicle which is disposed close to the users' ears. The patent document of the related art is KR 10-2003-0082892 A.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to a worm wheel gear for a BLDC motor that makes it possible to increase the contact area with a shift gear, increase efficiency of transmitting power through a structure that can distribute stress due to excessive engagement, and reduce a noise that may be generated in driving.

Various aspects of the present invention provide for a worm wheel gear for a BLDC motor which transmits the operation of a shift gear of an armature unit in a BLDC motor, the worm wheel gear including a worm wheel-threaded portion formed on the outer circumferential surface with one side of a thread groove recessed and open and the other side of the thread groove closed; a worm wheel central shaft formed at the center portion; and internal support members protruding from the worm wheel central shaft and connected to the inner circumferential surface of the worm wheel-threaded portion to support the worm wheel-threaded portion.

The thread groove of the worm wheel-threaded portion may be recessed in a semicircular shape, corresponding to the crest of the shift gear.

The worm wheel gear may further include a plurality of protrusions that protrudes toward the worm wheel central shaft from the internal circumferential surface of the worm wheel-threaded portion and comes in contact with the inner support members due to pressure applied from the outside in matching with the shift gear.

The internal support members may radially extend like spokes from the worm wheel central shaft and may be connected to the inner circumferential surface of the worm wheel-threaded portion to support the worm wheel-threaded portion.

The protrusions may be formed at regular intervals from the internal support members, has protruding ends disposed between the internal support members, and may come in contact with the adjacent internal support members due to pressure applied from the outside in matching with the shift gear to distribute the pressure applied from the outside. In particular, the protrusion may have an extending area that convexly extends at the end.

Other aspects of the present invention provide for a worm wheel gear for a BLDC motor which transmits the operation of a shift gear of an armature unit in a BLDC motor, the worm wheel gear including a worm wheel-threaded portion matching with a shift gear of the BLDC motor; a worm wheel central shaft formed at the center portion; internal support members protruding toward the worm wheel central shaft and connected to the inner circumferential surface of the worm wheel-threaded portion to support the worm wheel-threaded portion; and a plurality of protrusions that protrudes from the worm wheel central shaft from the inner circumferential surface of the worm wheel-threaded portion and comes in contact with the internal support members due to pressure applied from the outside in matching with the shift gear.

The internal support members may radially extend like spokes from the worm wheel central shaft and may be connected to the inner circumferential surface of the worm wheel-threaded portion.

The protrusions may be formed at regular intervals from the internal support members, has protruding ends disposed between the internal support members, and may come in contact with the adjacent internal support members due to pressure applied from the outside in matching with the shift gear to distribute the pressure applied from the outside. In particular, the protrusion may have an extending area that convexly extends at the end.

According to various aspects of the present invention, since one side of the thread groove is open and the other side is closed to increase the contact area with the shift gear, a worm wheel gear for a BLDC motor can increase efficiency of transmitting operation and reduce an operational noise by increasing the contact area with the shift gear.

According to various aspects of the present invention, since the extending areas of the protrusions come in contact with the internal support members at the left and right sides due to pressure applied from the outside in matching with the shift gear in the worm wheel gear for a BLDC motor, it is possible to distribute the pressure applied from the outside in matching with the shift gear.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a worm wheel gear for a BLDC motor of the related art.

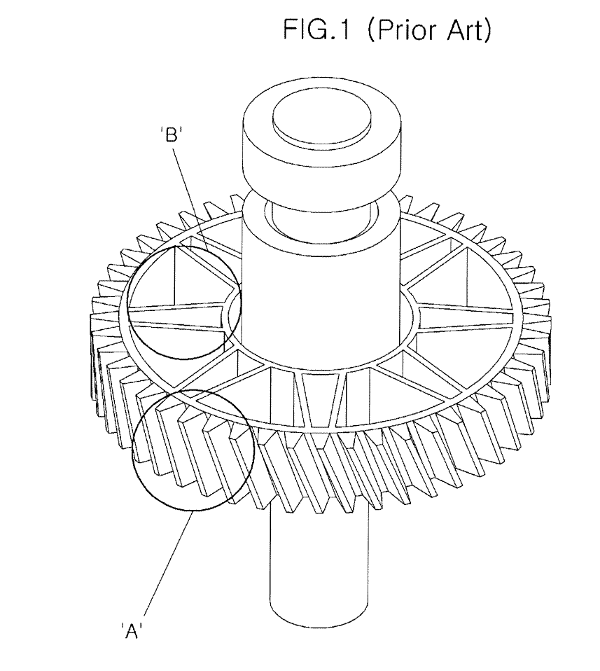

FIG. 2 is a plan view of a worm wheel gear for an exemplary BLDC motor according to the present invention.

FIG. 3 is a conceptual view showing a transverse cross-section for showing the matching state of the worm wheel gear for an exemplary BLDC motor according to the present invention and a shift gear.

FIG. 4 is a conceptual view showing a transverse cross-section for showing the matching state of the worm wheel gear for a BLDC motor of the related art to compare the state with FIG. 3.

FIG. 5 is a view showing the matching state of the worm wheel gear for an exemplary BLDC motor according to the present invention is matched with a shift gear.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

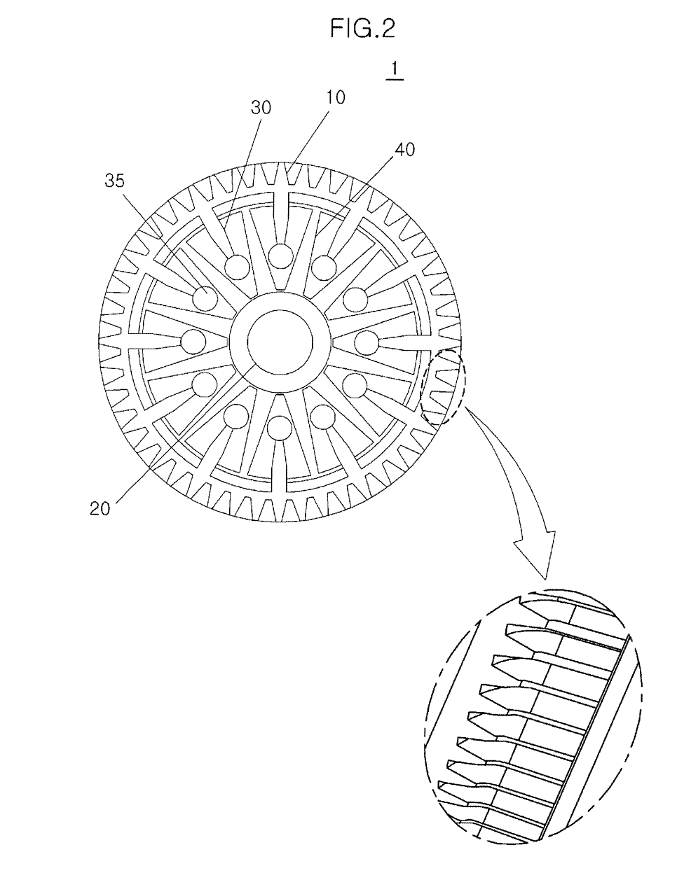

Referring to FIG. 2, a worm wheel gear 1 for a BLDC motor according to various embodiments includes a worm wheel-threaded portion 10, a work wheel central shaft 20, internal support members 40, and protrusions 30, in order to transmit the operation of a shift gear of an armature unit of the BLDC motor.

Worm wheel-threaded portion 10 is formed on the outer circumferential surface, with one side of the thread groove is recessed and the other side of the thread groove is closed. Worm wheel central shaft 20 is disposed at the center portion of worm wheel gear 1 of BLDC motor according to various embodiments and functions as a driving shaft.

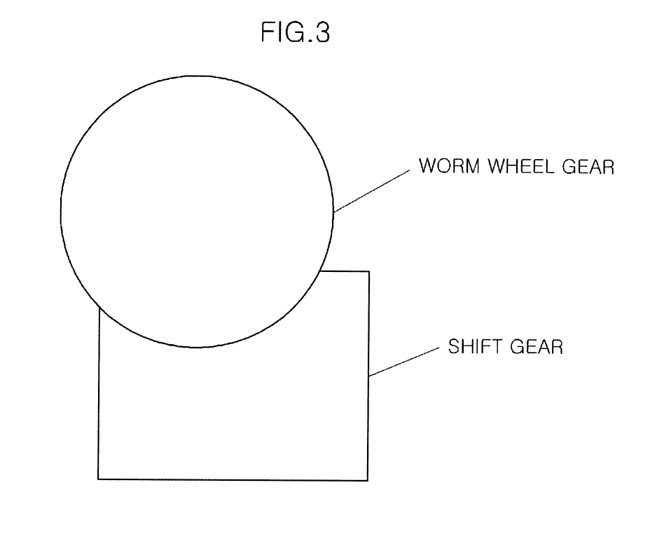

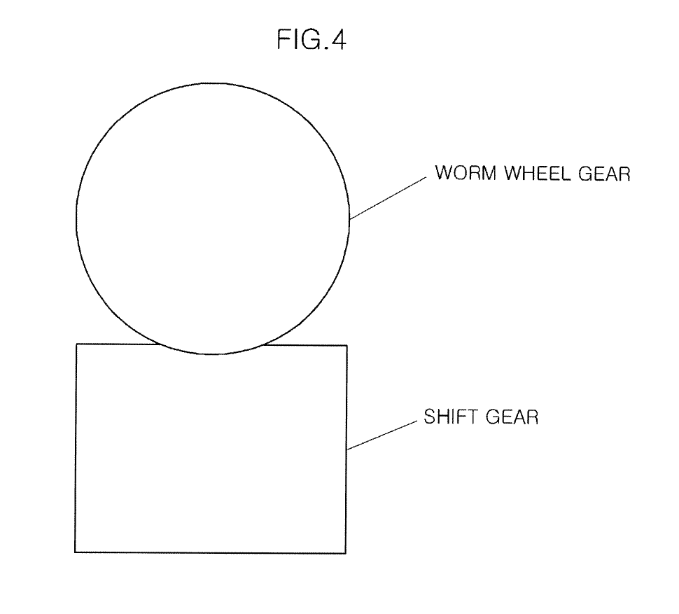

The thread groove is recessed in a semicircular shape to maximize the contact surface between the shift gear and the crest, as can be seen from FIG. 3. FIG. 4 is a conceptual view of a transverse cross-section in matching of the worm wheel gear for a BLDC motor of the related art, in which it can be seen that the contact area between the shift gear and the worm wheel gear is smaller than that in various embodiments.

As described above, since one side of the thread groove is open and the other side is closed to increase the contact area with the shift gear, worm wheel gear 1 for a BLDC motor according to various embodiments of the present invention can increase the contact area with the shift gear and reduce an operational noise.

Internal support members 40 protrude from worm wheel central shape 20 and is connected and supported to the inner circumferential surface of worm wheel-threaded portion 10, as shown in FIG. 2. Internal support members may be formed in like spokes radially arranged from the worm wheel central shaft, as shown in FIG. 2.

Protrusions 30 protrude toward worm wheel central shaft 20 from the inner circumferential surface of worm wheel-threaded portion 10, at regular intervals from internal support members 40, as shown in FIG. 2.

Protrusion 30 has an extending area 35 that convexly extends at the protruding end and is disposed at regular intervals between internal support members 40, as shown in FIG. 2.

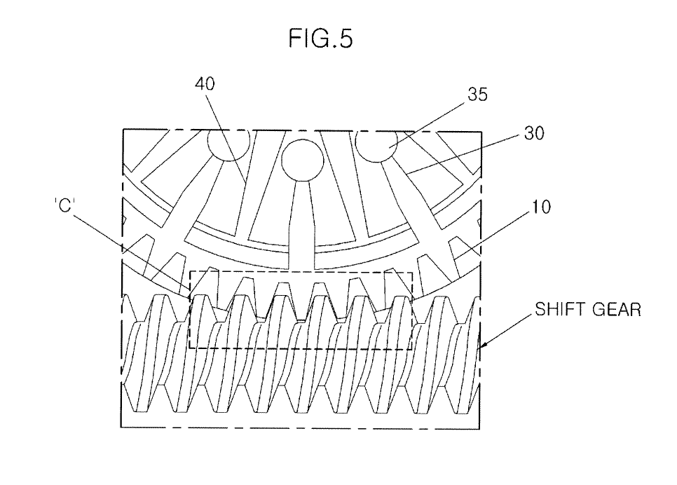

Extending areas 35 of protrusions 30 come in contact with internal support members 40 at the left and right sides by pressure applied from the outside when worm wheel gear 1 for a BLDC motor according to various embodiments is matched with the shift gear, as shown in FIG. 5, such that the pressure applied from the outside in matching with the shift gear can be distributed.

Since one side of the thread groove is open and the other side is closed to increase the contact area with the shift gear, Worm wheel gear 1 for a BLDC motor according to various embodiments of the present invention can increase the contact area with the shift gear.

Since protrusions 30 protrude toward worm wheel central shaft 20 from the inner circumferences of worm wheel-threaded portion 10 and are disposed between internal support members 40 in worm wheel gear 1 for a BLDC motor according to various embodiments of the present invention, it is possible to distribute the pressure applied from the outside in matching with the shift gear.

Worm wheel gear 1 for a BLDC motor according to various embodiments of the present invention includes both of worm wheel-threaded portion 10 and protrusions 30, but the worm wheel gear for a BLDC motor may be selectively provided with only one of the two components in various embodiments.

A BLDC motor according to various embodiments of the present invention may be used as a driving source for the sunroof of a vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A worm wheel gear for a BLDC motor which transmits the operation of a shift gear of an armature unit in a BLDC motor, the worm wheel gear comprising:
a worm wheel-threaded portion formed on an outer circumferential surface with one side of a thread groove recessed and open and another side of the thread groove closed;
a worm wheel central shaft formed at a center portion; and
internal support members protruding from the worm wheel central shaft and connected to an inner circumferential surface of the worm wheel-threaded portion to support the worm wheel-threaded portion.

2. The worm wheel gear as defined in claim 1, wherein the thread groove of the worm wheel-threaded portion is recessed in a semicircular shape, corresponding to a crest of the shift gear.

3. The worm wheel gear as defined in claim 1, further comprising a plurality of protrusions that protrude toward the worm wheel central shaft from the inner circumferential surface of the worm wheel-threaded portion and comes in contact with the internal support members due to pressure applied from the outside in matching with the shift gear.

4. The worm wheel gear as defined in claim 3, wherein the internal support members radially extend from the worm wheel central shaft and are connected to the inner circumferential surface of the worm wheel-threaded portion.

5. The worm wheel gear as defined in claim 4, wherein the protrusions are formed at regular intervals from the internal support members, has protruding ends disposed between the internal support members, and come in contact with the adjacent internal support members due to pressure applied from the outside in matching with the shift gear to distribute the pressure applied from the outside.

6. The worm wheel gear as defined in claim 5, wherein the protrusion has an extending area that convexly extends at the end.

7. The worm wheel gear as defined in claim 1, wherein the BLDC motor is used as a driving source for a sunroof of a vehicle.

8. A worm wheel gear for a BLDC motor which transmits the operation of a shift gear of an armature unit in a BLDC motor, the worm wheel gear comprising:
a worm wheel-threaded portion cooperating with a shift gear of the BLDC motor;
a worm wheel central shaft formed at a center portion;
internal support members protruding from the worm wheel central shaft and connected to an inner circumferential surface of the worm wheel-threaded portion to support the worm wheel-threaded portion; and
a plurality of protrusions that protrudes toward the worm wheel central shaft from the inner circumferential surface of the worm wheel-threaded portion and come contact with the internal support members due to pressure applied in meshing with the shift gear.

9. The worm wheel gear as defined in claim 8, wherein the internal support members radially extend from the worm wheel central shaft and are connected to the inner circumferential surface of the worm wheel-threaded portion.

10. The worm wheel gear as defined in claim 9, wherein the protrusions are formed at regular intervals from the internal support members, have protruding ends disposed between the internal support members, and come in contact with the adjacent internal support members due to pressure applied in meshing with the shift gear to distribute the pressure applied from the outside.
